(19) United States
(12) Patent Application Publication
(10) Pub. No.: US 2016/0088292 A1
(43) Pub. Date: Mar. 24, 2016

(54) ELECTRONIC APPARATUS, VIDEO SYSTEM AND EYEGLASS DEVICE

(71) Applicants: Kabushiki Kaisha Toshiba, Tokyo (JP); Toshiba Lifestyle Products & Services Corporation, Tokyo (JP)

(72) Inventors: Hirofumi Sakurai, Kumagaya Saitama (JP); Masatoshi Sano, Fukaya Saitama (JP); Hisayuki Mihara, Kodama Saitama (JP)

(21) Appl. No.: 14/638,957

(22) Filed: Mar. 4, 2015

(30) Foreign Application Priority Data
Sep. 24, 2014 (JP) 2014-193619

(51) Int. Cl. H04N 13/04; H04N 13/00; G09G 3/34; H04N 9/30

(52) U.S. Cl. CPC H04N 13/0497; H04N 9/30; H04N 13/0438; H04N 13/0422; H04N 13/0055; G09G 3/3413; G09G 2330/021; G09G 2320/064

(57) ABSTRACT

One embodiment provides an electronic apparatus. The electronic apparatus includes a display panel; a backlight; a sync processor; a backlight driver; and a transmitter. The display panel displays an image. The backlight illuminates the display panel from its back side. The sync processor generates a backlight control signal according to sync pulses that indicate respective vertical sync periods for frame-by-frame display of the image on the display panel, or a shutter control signal for opening/closure control of a shutter provided in eyeglasses in synchronism with the backlight control signal. The backlight driver receives the backlight control signal generated by the sync processor, and to cause the backlight to be lit during a prescribed period of each vertical sync period. The transmitter configured to send the backlight control signal or the shutter control signal outward.

### CROSS-REFERENCE TO RELATED APPLICATION(S)

This application claims priority from Japanese Patent Application No. 2014-193619 filed on Sep. 24, 2014, the entire contents of which are incorporated herein by reference.

### FIELD

An embodiment described herein generally relates to an electronic apparatus, a video system, and an eyeglass device.

### BACKGROUND

In living spaces such as living rooms, plural persons gather. The individual persons may do different things such as reading of a book and viewing of an image displayed on the screen of a TV receiver or a portable terminal.

For example, a bright environment may be suitable for reading of a book. On the other hand, a dark environment may be preferable for viewing of an image displayed on the screen of a TV receiver or a portable terminal. It is difficult to satisfy both environmental desires in a single space. The same may be true in outdoor spaces.

In general, when an environmental brightness is relatively high with respect to a screen luminance of a TV receiver, an image displayed on the TV receiver is made easier to see though if the viewer wears an eyeglass device such as sunglasses.

Incidentally, eyeglasses in which left and right liquid crystal shutters are alternately turned on/off may be used for viewing a 3D image.

Conventional 3D eyeglasses are just for viewing a 3D image, and do not contribute to remedy the above-mentioned situations.

On the other hand, if the screen luminance of the TV receiver is simply increased so as to match the environmental brightness, although the image may be made easier to see, the power consumption may also increase. This is disadvantageous especially for battery-driven electronic apparatus such as portable terminals.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates a video system according to a first embodiment.

FIG. 2 illustrates a detailed configuration of the video system shown in FIG. 1.

FIG. 3 illustrates a relationship between the on-period and the current of an LED backlight.

FIG. 4 illustrates a timing relationship between a vertical sync signal for a liquid crystal panel, a backlight lighting signal, and a liquid crystal shutter opening/closing operation.

FIG. 5 illustrates the effects of the video system according to the first embodiment.

FIG. 6 illustrates a video system according to a second embodiment.

FIG. 7 illustrates a video system according to a third embodiment.

### DETAILED DESCRIPTION

One embodiment provides an electronic apparatus. The electronic apparatus includes a display panel; a backlight; a sync processor; a backlight driver; and a transmitter. The display panel displays an image. The backlight illuminates the display panel from its back side. The sync processor generates a backlight control signal according to sync pulses that indicate respective vertical sync periods for frame-by-frame display of the image on the display panel, or a shutter control signal for opening/closure control of a shutter provided in eyeglasses in synchronism with the backlight control signal. The backlight driver receives the backlight control signal generated by the sync processor, and to cause the backlight to be lit during a prescribed period of each vertical sync period. The transmitter configured to send the backlight control signal or the shutter control signal outward.

Embodiments will be hereinafter described in detail with reference to the drawings.

### Embodiment 1

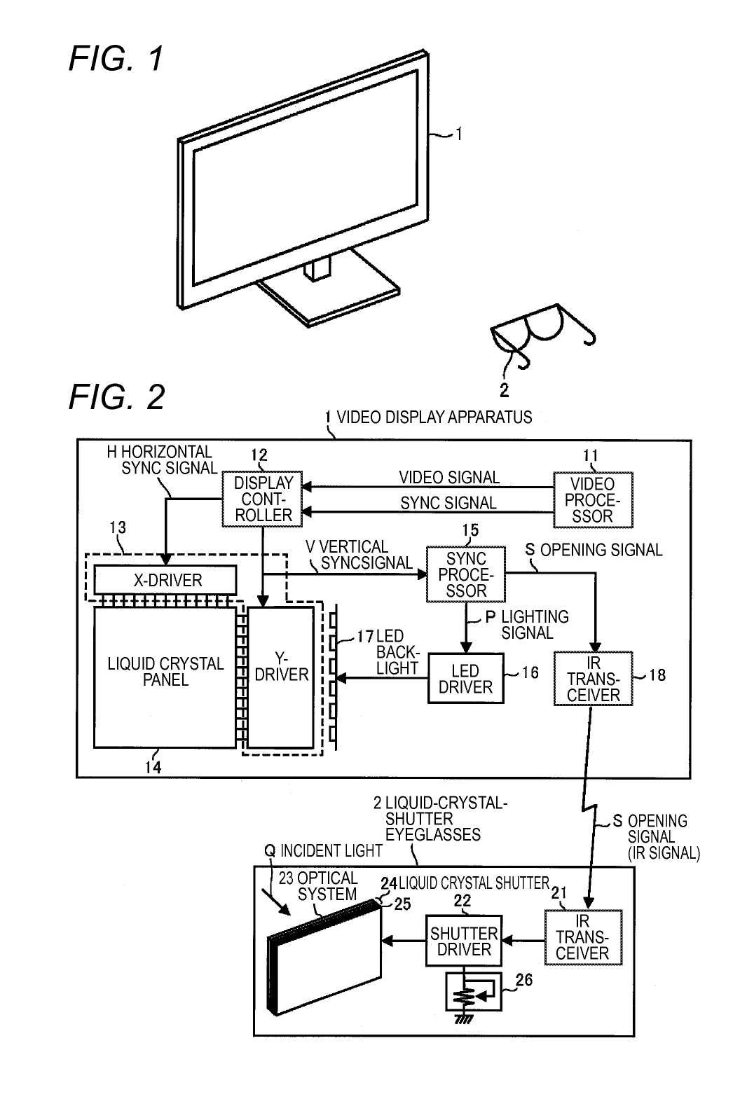

FIG. 1 shows a video system according to a first embodiment. As shown in FIG. 1, the video system according to a first embodiment is composed of a video display apparatus 1 and liquid-crystal-shutter eyeglasses 2 which are an eyeglass device.

The video display apparatus 1 is, for example, one having a function of receiving and displaying a ground-wave digital TV broadcast and is assumed to be installed indoors, for example, in a living room. The video display apparatus 1 is equipped with a video processor 11, a display controller 12, a liquid crystal driver 13 having an X-driver and a Y-driver, a liquid crystal panel 14, a sync processor 15 (signal generator), an LED driver 16, an LED backlight 17, an IR transceiver 18 (transceiver/transmitter), etc.

The video processor 11 is provided with a tuner for receiving a ground-wave digital TV broadcast and various signal processing functions from a function of generating a video signal and a sync signal from the received broadcast to a function of outputting them to the display controller 12.

The display controller 12 receives the video signal and the sync signal from the video processor 11 and outputs, to the liquid crystal driver 13, a horizontal sync signal H and a vertical sync signal V for drawing of an image on the liquid crystal panel 14.

The liquid crystal driver 13 draws an image of the video signal on the liquid crystal panel 14 as the X-driver drives scanning electrodes of the liquid crystal panel 14 on the basis of the horizontal sync signal H and the Y driver drives signal electrodes of the liquid crystal panel 14 on the basis of the vertical sync signal V.

The liquid crystal panel 14 is configured in such a manner that optical filters (a polarizing filter and color filters), polarizing plates, etc. are laid on alignment films between which liquid crystal molecules are sandwiched. The liquid crystal panel 14 as a whole displays an image by controlling the transmission amounts of light that is emitted from an LED backlight 17 (disposed behind the liquid crystal panel 14) by varying the orientation of the liquid crystal molecules electrically. The liquid crystal panel 14 is of the in-plane switching (IPS) type, the vertical alignment (VA) type, or the like.

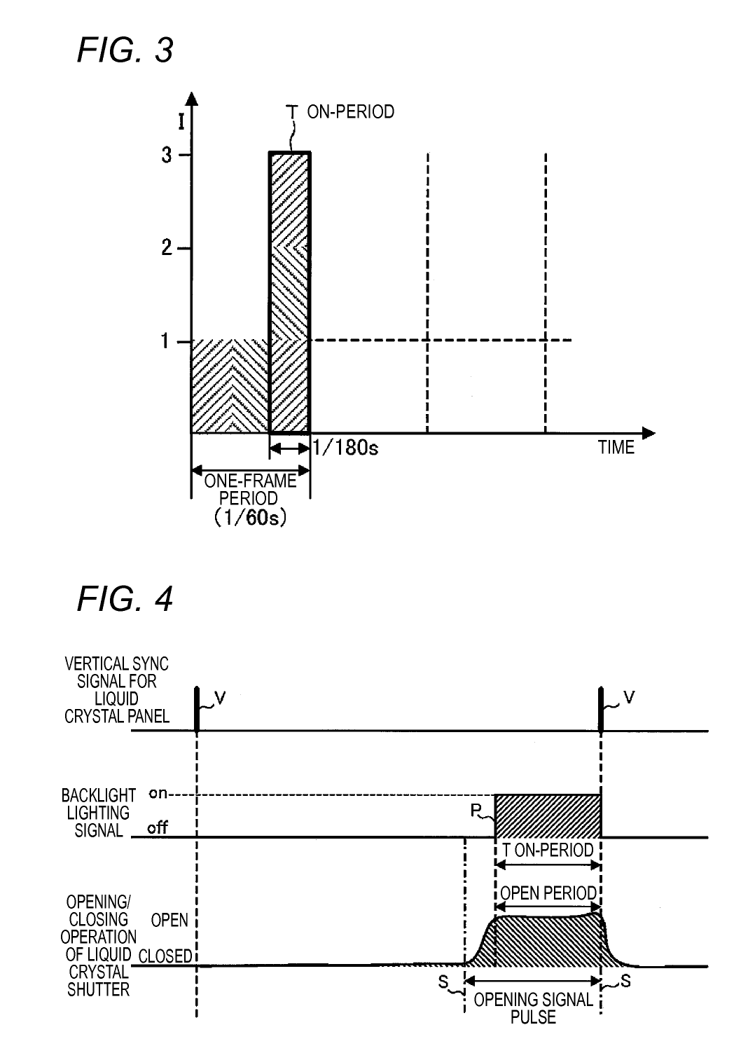

The LED driver 16 outputs, to the LED backlight 17, a control signal (in this example, lighting signal P) for controlling the turning-on/off of the LED backlight 17. That is, the LED driver 16 functions as a backlight driver which receives the lighting signal P generated by the sync processor 15 and causes the LED backlight 17 to be lit in a prescribed period (on-period T (see FIGS. 3 and 4)) of each vertical sync period.

The LED driver 16 turns on the LED backlight 17 in synchronism with an opening operation of the liquid crystal shutter 24 and turns off the LED backlight 17 in synchronism with a closing operation of a liquid crystal shutter 24.

The LED backlight 17 is configured in such a manner that a plate-like member on which plural LEDs are arranged is disposed behind the liquid crystal panel 14. The LEDs are turned on according to the lighting signal P, and thereby illuminate the liquid crystal panel 14 from behind and enable viewing of an image.

The sync processor 15 generates a shutter control signal (in this example, opening signal S) for opening/closure-controlling the liquid crystal shutter 24 and a backlight control signal (in this example, lighting signal P) for turning-on/off control of the LED backlight 17 on the basis of the received vertical sync signal V. The sync processor 15 outputs the lighting signal P and the opening signal S to the LED driver 16 and the IR transceiver 18, respectively.

Although in this example the sync processor 15 generates the opening signal S and the lighting signal P, the sync processor 15 may generate opposite signals, that is, a closing signal indicating closing timing of the liquid crystal shutter 24 and a turn-off signal for turning off the LED backlight 17.

That is, the sync processor 15 generates the lighting signal P according to the sync signal (vertical sync signal V) indicating vertical sync periods for frame-by-frame display of an image on the liquid crystal panel 14 and generates the opening signal S for opening/closure-controlling the liquid crystal shutter 24 of the liquid-crystal-shutter eyeglasses 2 in synchronism with the lighting signal P.

The IR transceiver 18 sends the opening signal S received from the sync processor 15 to the liquid-crystal-shutter eyeglasses 2 by an infrared (IR) communication. That is, the IR transceiver 18 functions as a transmitter to transmit the opening signal S to the liquid-crystal-shutter eyeglasses 2 which is an external cooperation device.

Instead of the IR communication method, a radio communication method such as Bluetooth (registered trademark) or wireless LAN may be used for communication with the liquid-crystal-shutter eyeglasses 2.

The liquid-crystal-shutter eyeglasses 2 are equipped with an IR transceiver 21 (transceiver/receiver), a shutter driver 22, an optical system 23, and a dimmer 26.

The IR transceiver 21 functions as a receiver to receive the opening signal S that is transmitted from the video display apparatus 1 by an IR communication and supplies it to the shutter driver 22.

The shutter driver 22 controls (drives) the liquid crystal shutter 24 according to the opening signal S received from the IR transceiver 21 so that the liquid crystal shutter 24 is opened and closed with the same timing as the LED backlight 17 is turned on and off, respectively.

The opening signal S as a control signal for controlling (driving) the liquid crystal shutter 24 is an on-signal for opening it. Where a closing signal is used instead of the opening signal S, the closing signal is an off-signal for closing the liquid crystal shutter 24.

The optical system 23, which receives light coming from an image that is displayed on the liquid crystal panel 14, is composed of the liquid crystal shutter 24 and a color filter 25 which is a band rejection filter. The optical system 23 may either consist of two (left and right) independent systems or be a single-surface system.

The liquid crystal shutter 24 is configured in such a manner that a liquid crystal layer is sandwiched between two polarizing plates and is incorporated in the optical system 23 with the color filter 25. Opened or closed electrically, the liquid crystal shutter 24 transmits or stops incident light. Alternatively, a mechanical shutter may be used if it is capable of high-speed opening and closure.

The polarizing plates have a function of transmits single polarization light and attenuates random polarization light. In this example, light of an image displayed on the liquid crystal panel 14 is single polarization light, and room illumination light, external light coming from outside the room, and wall (or screen)-reflected light of those kinds of light are random polarization light.

The polarizing plates that are incorporated in the optical system 23 attenuate illumination light and external light approximately by half and hence provide an effect of increasing the contrast of an image.

The color filter 25 is disposed on one surface of the liquid crystal shutter 24 (in this example, on the surface opposite to the surface on which light Q is incident). The color filter 25 is an optical filter that cuts part of incident light in a particular wavelength range(s), such as an RGB filter. The RGB filter serves to transmit RGB-wavelength light of an image displayed on the liquid crystal panel 14 and attenuates light in the other wavelength ranges. The RGB filter therefore has a function of attenuating continuous wavelength light, examples of which are illumination light, external light, and reflection light thereof. Thus, the use of the color filter 25 provides an effect of reducing the attenuation of image and expanding its gamut.

Opened or closed electrically, the liquid crystal shutter 24 transmits or stops incident light. The principle of operation of the liquid crystal shutter 24 is thus approximately the same as that of the liquid crystal panel 14.

The dimmer 26, which serves to adjust the opening/closure dimming range of the liquid crystal shutter 24, is equipped with a photosensor. The photosensor detects an ambient light quantity and the dimmer 26 adjusts the transmission light quantity of the optical system 23 in accordance with the detected ambient light quantity. The dimmer 26 reduces the transmission light quantity as the ambient brightness increases. As such, the dimmer 26 serves to vary the transmission light quantity of the eyeglasses 2 as a whole and hence provides an effect of dimming sunglasses.

The user himself or herself may adjust the transmission light quantity by manipulating a volume without use of an optical sensor. The optical system 23 may also be provided with a diopter adjusting function, for example.

In this TV system (video system), as the video display apparatus 1 displays an image on the liquid crystal panel 14, it supplies the sync processor 15 with the same vertical sync signal V as it outputs to the liquid crystal panel 14. The sync processor 15 generates a lighting signal P and an opening signal S from the received vertical sync signal V. The sync processor 15 outputs the lighting signal P to the LED driver 16 and outputs the opening signal S to the IR transceiver 18, which sends it to the liquid-crystal-shutter eyeglasses 2 by a wireless communication.

The LED driver 16 turns on the LED backlight 17 with timing that is indicated by the received lighting signal P (see an on-period T shown in FIGS. 3 and 4). The LED backlight 17 is not lit during the period other than the on-period T.

On the other hand, in the liquid-crystal-shutter eyeglasses 2 which have received the opening signal S, the shutter driver 22 drives (opens and closes) the liquid crystal shutter 24 according to the opening signal S.

Now, a relationship between the turn-on timing and the current of the LED backlight 17 will be described with reference to FIG. 3.

As shown in FIG. 3, assuming that the one-frame period (i.e., the period in which a one-frame image is drawn) is equal to 1/60 sec, for example), the sync processor 15 outputs a lighting signal P and thereby turns on the LED backlight 17 only during a portion (e.g., a period of 1/180 sec), adjacent to the next frame, of the one-frame period.

The LED backlight 17 is not lit during the preceding period of 2/180 sec. That is, the LED backlight 17 is lit during a prescribed period (e.g., 1/180 sec when the duty ratio is 33% and 1/150 sec when the duty ratio is 40%), before arrival of the next pulse of the vertical sync signal V, of each one-frame vertical sync period.

From the viewpoint of energy consumption, a current of 1 A flowing for 1/60 sec is equivalent to a current of 3 A flowing for 1/180 sec. An operation mode in which a current of 1 A is caused to flow for each 1/180 sec when the luminance of the LED backlight 17 need not have a value corresponding to 3 A is lower in energy consumption than an operation mode in which the LED backlight 17 is lit by causing a current of 1 A to flow through it for each 1/60 sec irrespective of the situation. That is, an operation mode is possible in which the LED backlight 17 is kept off during periods other than periods when the liquid crystal shutter 24 is opened and a current that is increased by a proportion corresponding to the insertion of the off-period is caused to flow through the LED backlight 17 during the open periods.

Next, how the TV system according to the embodiment operates will be described with reference to a timing chart of FIG. 4.

Since the opening signal S is transmitted to the liquid-crystal-shutter eyeglasses 2 by an IR communication, the liquid crystal shutter 24 is opened in synchronism with the turn-on timing of the LED backlight 17.

In the video display apparatus 1, as shown in FIG. 4, the LED backlight 17 is lit during a certain period between adjoining pulses of the vertical sync signal V for the liquid crystal panel 14.

The turn-on timing of the LED backlight 17 is set at any position in a fully-switched-on period (i.e., a period when a one-frame image is drawn) of the liquid crystal panel 14. However, the LED backlight 17 needs to be turned off before arrival of the next pulse of the vertical sync signal V.

Therefore, as shown in FIG. 4, the on-period T of the lighting signal P of the LED backlight 17 is set the same as the open period of the liquid crystal shutter 24 with their ends set at a position immediately before the start of the next frame.

Since a delay occurs before the liquid crystal shutter 24 is opened completely, the width of the opening signal S is set greater than the on-period T of the LED backlight 17.

While the duty ratio is optional, generally, the contrast enhancement effect increases as the duty ratio decreases.

As the duty ratio decreases, the on-period of the LEDs of the LED backlight 17 becomes shorter and hence the power consumption of the LED backlight 17 can be lowered.

This is because the current flowing through the LED backlight 17 can be increased as a result of increasing periods when the LED backlight 17 is not lit. Therefore, the instantaneous luminance of the liquid crystal panel 14 (TV screen) can be increased and hence the contrast of the liquid crystal panel 14 with respect to the brightness of an environment can be made higher.

### Advantages

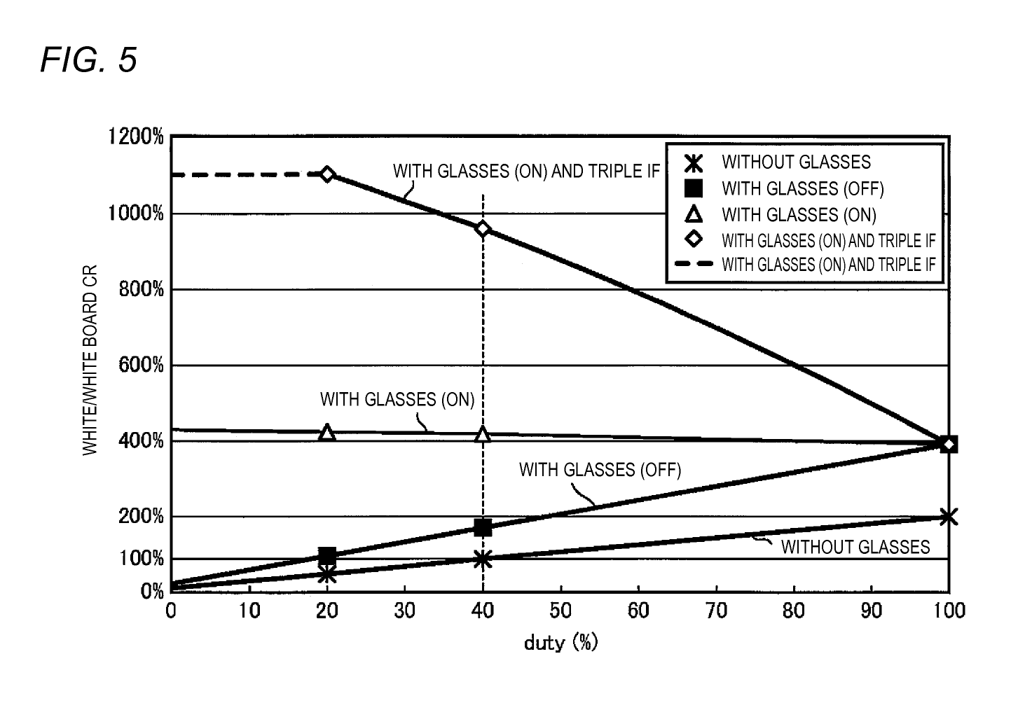

Advantages of the TV system according to the embodiment will be described with reference to FIG. 5 which shows experimental data and prediction values (estimation values) in a TV system operating at 60 Hz. FIG. 5 shows results of measurements of contrast between a white image displayed on the screen of the liquid crystal panel 14 under illumination and the brightness of an environment which is a white wall (hereinafter referred to as a “white board”).

As shown in FIG. 5, contrast (white/white board CR) of the screen (white) of the liquid crystal panel 14 with respect to the environment (white board) that is obtained with a duty ratio 40% (the position indicated by the broken line) in a state that the user does not wear the liquid-crystal-shutter eyeglasses 2 (curve *; hereinafter referred to as “without glasses”) is assumed to be 100%. If the duty ratio is increased to 100% (full lighting of the backlight 17) in this state, the contrast (white/white board CR) increases to about 200%.

Contrast (white/white board CR) that is obtained with the duty ratio 40% in a state that the liquid crystal shutter 24 of the liquid-crystal-shutter eyeglasses 2 is kept open (curve ▪ in FIG. 5; referred to as “with glasses (off)”) becomes equal to about 180% (approximately doubled). This is due to the effect that a random polarization component of incident light on the optical system 23 is interrupted by the polarizing plates.

Contrast (white/white board CR) that is obtained with the duty ratio 40% in a state that an opening/closure control is performed on the liquid-crystal-shutter eyeglasses 2 and a turn-on/off control is performed on the LED backlight 17 of the liquid crystal panel 14 (i.e., both of the LED backlight 17 and the liquid crystal shutter 24 are driven; curve Δ in FIG. 5; referred to as “with glasses (on)”) exceeds 400%. That is, the contrast becomes approximately four times the value of the case “without glasses.”

If the LED current If is tripled in the above state (curve ⋄ in FIG. 5; referred to as “with glasses (on) and triple If”), contrast (white/white board CR) that is obtained with the duty ratio 40% reaches 950%. That is, the contrast becomes approximately 9.5 times the value of the case “without glasses.”

As described above, in the video system according to the first embodiment, the LED backlight 17 of the liquid crystal panel 14 is lit during a prescribed period of each short, one-frame period for drawing of a one-frame image and the liquid crystal shutter 24 of the liquid-crystal-shutter eyeglasses 2 is opened in synchronism with the lighting of the LED backlight 17. And the LED backlight 17 is kept off and the liquid crystal shutter 24 is closed during the other period. As a result, the contrast of the screen lightness with respect to the ambient lightness in a bright place is increased, whereby the visibility of an image displayed on the liquid crystal panel 14 can be made higher.

In this embodiment, the opening signal S is merely sent from the video display apparatus 1 in the form of infrared light, the number of pairs of eyeglasses 2 that can be used simultaneously is not limited as long as they are located within the reach of infrared light, enabling viewing by plural (many) users.

The visibility is made higher by increasing the current flowing through the LED backlight 17. On the other hand, an energy saving effect is expected on the side of the video display apparatus 1 if the LED current is set smaller than in the ordinary case and the LED backlight 17 is made off while the liquid crystal shutter 24 is closed.

### Embodiment 2

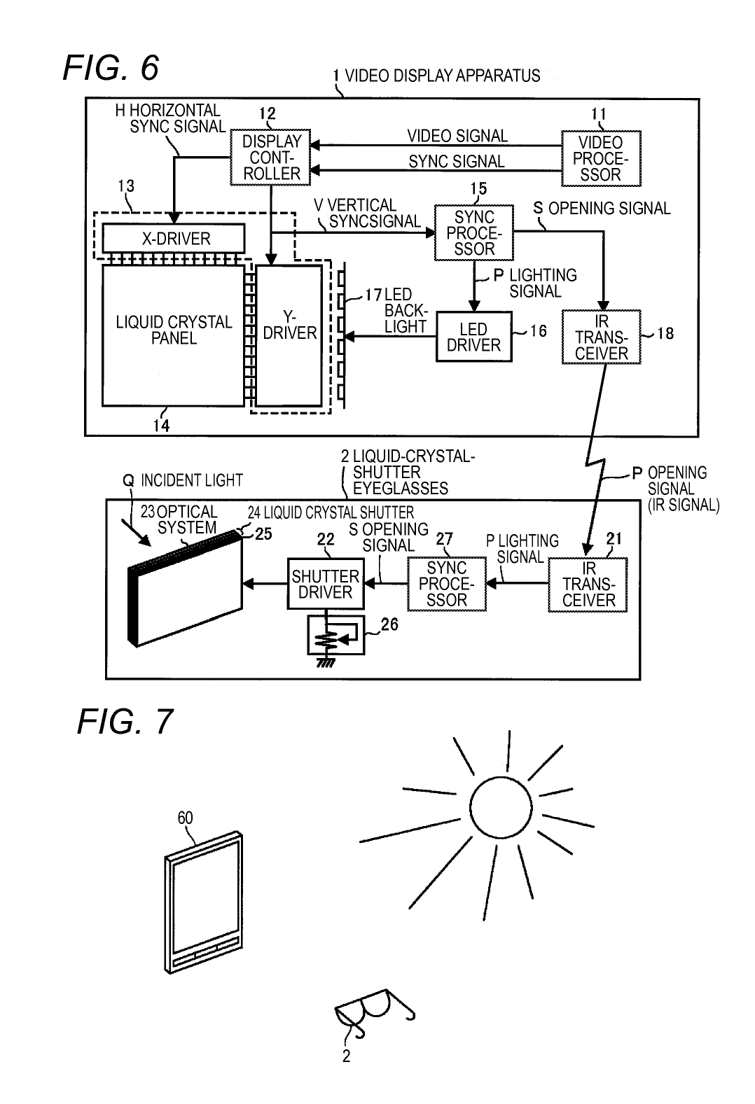

FIG. 6 shows a video system according to a second embodiment. As shown in FIG. 6, in the video system according to the second embodiment, a video display apparatus 1 is equipped with a sync processor 19 and liquid-crystal-shutter eyeglasses 2 are equipped with a sync processor 27.

The sync processor 19 generates a control signal (in this example, lighting signal P) for controlling the turning-on/off of the LED backlight 17 from a received vertical sync signal V and outputs the generated lighting signal P to the LED driver 16 and the IR transceiver 18. While the lighting signal is exemplified, a turn-off signal for turning off the LED backlight 17 may be alternatively used.

The IR transceiver 18 sends the lighting signal P received from the sync processor 19 to the liquid-crystal-shutter eyeglasses 2 by an infrared (IR) communication.

The IR transceiver 21 receives the lighting signal P that is transmitted from the video display apparatus 1 by an IR communication, and supplies the received lighting signal P to the sync processor 27.

The sync processor 27 generates an opening signal S whose pulses are longer than the pulses of the lighting signal P on the basis of the lighting signal P received from the IR transceiver 21.

As described above, in the video system according to the second embodiment, the video display apparatus 1 sends out a lighting signal P which is a control signal for controlling the turning-on/off of the LED backlight 17. In the liquid-crystal-shutter eyeglasses 2, the lighting signal P is converted into an opening signal S, which is used for driving the liquid crystal shutter 24. In this manner, the second embodiment provides the same advantages as the first embodiment. In the second embodiment, whereas the sync processor 19 of the video display apparatus 1 is simplified, it is necessary to add the sync processor 27 in the liquid-crystal-shutter eyeglasses 2.

### Embodiment 3

FIG. 7 shows a video system according to a third embodiment which is a modification of the video system according to the first or second embodiment. As shown in FIG. 7, in the video system according to the third embodiment, a smartphone 60 (portable terminal) which is an electronic apparatus that a user carries outdoors and uses there replaces the above-mentioned video display apparatus 1 that is installed indoors and used there is combined with the above-mentioned liquid-crystal-shutter eyeglasses 2 which are used in the first or second embodiment. Another kind of electronic apparatus such as a tablet terminal or a notebook computer may be used in place of the smartphone 60.

When the smartphone 60 is used in an environment with exposure to sunlight, an image displayed on its screen tends to feel dark and be difficult to see. However, the contrast is increased by virtue of the use of the liquid-crystal-shutter eyeglasses (see FIG. 2 or 6) which has the above-described polarizing function (polarizing plates), wavelength control function (color filter 25), and function of controlling the opening/closure timing of the liquid crystal shutter 24. Therefore, the user is allowed to view an image on the smartphone 60 easily even outdoors.

As described above, the video system according to the third embodiment can improve the visibility of an image displayed on the liquid crystal panel 14 even outdoors and thereby allows the user to view an image on the smartphone 60 easily even outdoors.

Although the embodiments have been described above, they are just examples and should not be construed as restricting the scope of the invention. Each of these novel embodiments may be practiced in various other forms, and part of it may be omitted, replaced by other elements, or changed in various manners without departing from the spirit and scope of the invention. These modifications will also fall within the scope of the invention.

One or more constituent elements of the video display apparatus 1 according to each embodiment may be implemented by programs that are installed in a storage such as a hard disk drive of a computer. The functions of the invention may be implemented by a computer by storing such programs in a computer-readable electronic medium and causes the computer to read the programs from the electronic medium. Examples of the electronic medium are a flash memory, removable media, and such recording media as a CD-ROM. Furthermore, the functions of the invention may be implemented by storing constituent elements in a distributed manner in different computers that are connected to each other by a network and causing the computers in which the constituent elements are in operation to communicate with each other.

1. An electronic apparatus comprising:
a display panel configured to display an image;
a backlight configured to illuminate the display panel from its back side;
a sync processor configured to generate
a backlight control signal according to sync pulses that indicate respective vertical sync periods for frame-by-frame display of the image on the display panel, or
a shutter control signal for opening/closure control of a shutter provided in eyeglasses in synchronism with the backlight control signal;
a backlight driver configured to receive the backlight control signal generated by the sync processor, and to cause the backlight to be lit during a prescribed period of each vertical sync period; and
a transmitter configured to send the backlight control signal or the shutter control signal outward.

2. The electronic apparatus of claim 1,
wherein the backlight driver turns off the backlight in synchronism with a closing operation of the shutter.

3. The electronic apparatus of claim 1,
wherein the backlight driver turns on the backlight in synchronism with an opening operation of the shutter.

4. The electronic apparatus of claim 1,
wherein the prescribed period during which the backlight lit in each vertical sync period of one frame is defined to end at a time immediately before a rise of the next sync pulse.

5. The electronic apparatus of claim 4,
wherein the backlight driver keeps the backlight off during a closed period that is a period other than an open period of the shutter and causes an increased current to flow through the backlight during the open period.

6. A video system comprising:
an electronic apparatus for displaying an image on a display panel thereof; and
an eyeglass device for viewing of the image displayed on the display panel,
wherein the electronic apparatus comprises:
a backlight configured to illuminate the display panel from its back side;
a sync processor configured to generate
a backlight control signal according to sync pulses that indicate respective vertical sync periods for frame-by-frame display of the image on the display panel, or
a shutter control signal for opening/closure control of a shutter provided in the eyeglass device in synchronism with the backlight control signal;
a backlight driver configured to receive the backlight control signal generated by the sync processor, and to cause the backlight to be lit during a prescribed period of each vertical sync period; and
a transmitter configured to send the backlight control signal or the shutter control signal to the eyeglass device, and
wherein the eyeglass device comprises:
an optical system configured to receive light of the image displayed on the display panel, and includes a shutter which transmits or interrupts incident light as it is opening/closure-controlled electrically;
a receiver configured to receive
the backlight control signal, or
the shutter control signal; and
a shutter driver configured to control opening/closure of the shutter according to the received shutter control signal or a shutter control signal generated from the received backlight control signal so that the shutter is opened and closed with the same timing as the backlight is turned on and off, respectively.

7. The video system of claim 6,
wherein the optical system includes:
an optical filter which transmits a part of the light of the image, which falls within a prescribed wavelength range, and attenuates the other part of the light.

8. An eyeglass device for viewing of an image displayed on a display panel of an electronic apparatus, the eyeglass device comprising:
an optical system configured to receive light of the image displayed on the display panel, and includes a shutter which transmits or interrupts incident light as it is opening/closure-controlled electrically;
a receiver configured to receive, from the electronic apparatus,
a backlight control signal for turn-on/off control of a backlight of the display panel, or
a shutter control signal for opening/closure-controlling the shutter; and
a shutter driver configured to control opening/closure of the shutter according to the received shutter control signal or a shutter control signal generated from the received backlight control signal so that the shutter is opened and closed with the same timing as the backlight is turned on and off, respectively.
